(19) United States
(12) Patent Application Publication
(10) Pub. No.: US 2026/0142777 A1
(43) Pub. Date: May 21, 2026

(54) RESOURCE DENSITY FOR PHASE CHANGE ESTIMATION REFERENCE SIGNALS

(71) Applicant: QUALCOMM Incorporated, San Diego, CA (US)

(72) Inventors: Chih-Hao LIU, San Diego, CA (US); Jing JIANG, San Diego, CA (US); Jing SUN, San Diego, CA (US)

(21) Appl. No.: 18/949,554

(22) Filed: Nov. 15, 2024

(51) Int. Cl. H04L 5/00; H04L 1/00

(52) U.S. Cl. CPC H04L 5/0051; H04L 1/0003

(57) ABSTRACT

Methods, systems, and devices for wireless communications are described. The described techniques may enable a user equipment (UE) to be configured with a density of phase change estimation reference signals (RSs) for a modulation and coding scheme (MCS) and resource block (RB) allocation that may be based on a demodulation reference signal (DMRS) configuration and a quantity of antenna ports of the UE. For example, the UE may be configured with one or two resource elements (REs) for phase change estimation RSs a multiple of every 4, 12, or 6 REs. The configuration may be based on whether the UE has one or two antenna ports for phase change estimation RSs, and based on whether the UE is configured with a type 1 or type 2 DMRS configuration.

### FIELD OF TECHNOLOGY

The following relates to wireless communications, including resource density for phase change estimation reference signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a control message indicating a resource configuration for a set of phase change estimation RSs, where the resource configuration is based on a demodulation reference signal (DMRS) configuration, a quantity of antenna ports associated with the set of phase change estimation reference signals (RSs), a modulation and coding scheme (MCS), a resource block (RB) allocation for a physical shared channel satisfying a threshold quantity of RBs, or a combination thereof and communicating, via the physical shared channel, the set of phase change estimation RSs in accordance with the resource configuration.

A UE for wireless communications is described. The UE may include one or more memories storing processor executable code, and one or more processors coupled with the one or more memories. The one or more processors may individually or collectively be operable to execute the code to cause the UE to receive a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof and communicate, via the physical shared channel, the set of phase change estimation RSs in accordance with the resource configuration.

Another UE for wireless communications is described. The UE may include means for receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof and means for communicating, via the physical shared channel, the set of phase change estimation RSs in accordance with the resource configuration.

A non-transitory computer-readable medium storing code for wireless communications is described. The code may include instructions executable by one or more processors to receive a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof and communicate, via the physical shared channel, the set of phase change estimation RSs in accordance with the resource configuration.

In some examples of the method, UEs, and non-transitory computer-readable medium described herein, the resource configuration includes a phase change estimation RS of the set of phase change estimation RSs allocated to one resource element per set of resource elements based on the DMRS configuration including a type-one DMRS configuration, the quantity of antenna ports including one antenna port for the phase change estimation RS.

In some examples of the method, UEs, and non-transitory computer-readable medium described herein, the set of resource elements includes four resource elements, eight resource elements, or a multiple of twelve resource elements based on the type-one DMRS configuration.

In some examples of the method, UEs, and non-transitory computer-readable medium described herein, the resource configuration includes a respective phase change estimation RS of the set of phase change estimation RSs allocated to each of two resource elements per set of resource elements based on the DMRS configuration including a type-one DMRS configuration, the quantity of antenna ports including two antenna port for the respective phase change estimation RSs.

In some examples of the method, UEs, and non-transitory computer-readable medium described herein, the set of resource elements includes a multiple of four resource elements based on the type-one DMRS configuration.

In some examples of the method, UEs, and non-transitory computer-readable medium described herein, an orthogonal cover code (OCC) may be applied to the respective phase change reference signals and each resource element of the two resource elements may be separated by one resource element.

In some examples of the method, UEs, and non-transitory computer-readable medium described herein, the resource configuration includes a phase change estimation RS of the set of phase change estimation RSs allocated to one resource element per set of resource elements based on the DMRS configuration including a type-two DMRS configuration, the quantity of antenna ports including one antenna port for the phase change estimation RS.

In some examples of the method, UEs, and non-transitory computer-readable medium described herein, the set of resource elements includes a multiple of six resource elements based on the type-two DMRS configuration.

In some examples of the method, UEs, and non-transitory computer-readable medium described herein, the resource configuration includes a respective phase change estimation RS of the set of phase change estimation RSs allocated to each of two resource elements per set of resource elements based on the DMRS configuration including a type-two DMRS configuration, the quantity of antenna ports including two antenna port for the respective phase change estimation RSs.

In some examples of the method, UEs, and non-transitory computer-readable medium described herein, the set of resource elements includes six resource elements or twelve resource elements based on the type-two DMRS configuration.

In some examples of the method, UEs, and non-transitory computer-readable medium described herein, an OCC may be applied to the respective phase change reference signals.

In some examples of the method, UEs, and non-transitory computer-readable medium described herein, a density of the set of phase change estimation RSs may be based on a frequency domain resource allocation for the physical shared channel.

In some examples of the method, UEs, and non-transitory computer-readable medium described herein, a density of the set of phase change estimation RSs may be based on the MCS and the density may be from a set of densities that includes respective densities for different MCS thresholds.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resource density for phase change estimation reference signals in accordance with one or more aspects of the present disclosure.

FIG. 2 shows an example of a wireless communications system that supports resource density for phase change estimation reference signals in accordance with one or more aspects of the present disclosure.

FIGS. 3A and 3B show examples of resource diagrams that support resource density for phase change estimation reference signals in accordance with one or more aspects of the present disclosure.

FIGS. 4A and 4B show examples of resource diagrams that support resource density for phase change estimation reference signals in accordance with one or more aspects of the present disclosure.

FIGS. 5 and 6 show block diagrams of devices that support resource density for phase change estimation reference signals in accordance with one or more aspects of the present disclosure.

FIG. 7 shows a block diagram of a communications manager that supports resource density for phase change estimation reference signals in accordance with one or more aspects of the present disclosure.

FIG. 8 shows a diagram of a system including a device that supports resource density for phase change estimation reference signals in accordance with one or more aspects of the present disclosure.

FIG. 9 shows a flowchart illustrating methods that support resource density for phase change estimation reference signals in accordance with one or more aspects of the present disclosure.

### DETAILED DESCRIPTION

In some wireless communications systems, a transmitting device (e.g., a user equipment (UE) or a network entity) may transmit data transmissions (e.g., physical uplink shared channel (PUSCH) transmissions, physical downlink shared channel (PDSCH) transmissions) over multiple slots. In such cases, each slot may include a demodulation reference signal (DMRS) that is multiplexed with the transmissions and used to aid a receiving device in decoding the data transmission. In some cases, however, DMRS ports associated with DMRS transmissions in each slot may lack coherence (e.g., phase coherence), and a difference in phase between consecutive slots of the data transmission (e.g., a same PDCCH transmission) may affect decoding efficiency (e.g., because independent phase changes, or phase “jumps,” may need to be estimated per port).

Accordingly, a transmitting device may include an additional reference signal (e.g., a phase difference estimation reference signal (RS), a phase change estimation RS, a glue RS (gRS)) with a data transmission to enable the receiving device to determine the phase change between the consecutive slots. Relatively more phase change estimation RSs may enable the receiving device to estimate the phase change with relatively higher accuracy. However, a relatively higher density of phase change estimation RSs may result in relatively higher overhead, which may increase power consumption and decrease an efficiency of resource usage.

Techniques described herein may enable a network entity to configure a UE with a density of phase change estimation RSs for a modulation and coding scheme (MCS) and resource block (RB) allocation that may be based on a DMRS configuration and a quantity of antenna ports of the UE. In some examples, the quantity of REs configured for phase change estimation RSs may depend on a size of a RB allocation and/or an MCS. For example, if the UE has one antenna port for phase change estimation RSs and is configured with a type-1 DMRS configuration, the UE may be configured with one resource element (RE) for phase change estimation RSs every 4, 8, or a multiple of 12 REs. Additionally, or alternatively, if the UE has two antenna ports for phase change estimation RSs and is configured with a type 1 DMRS configuration, the UE may be configured with two REs for phase change estimation RSs every 4, 8, 12, or another multiple of 4 REs.

Additionally, or alternatively, if the UE as one antenna port for phase change estimation RSs and is configured with a type 2 DMRS configuration, the UE may be configured with one RE for phase change estimation RSs every 6, 12, or another multiple of 6 REs. Additionally, or alternatively, if the UE has two antenna ports for phase change estimation RSs and is configured with a type 2 DMRS configuration, the UE may be configured with two REs for phase change estimation RSs every 6, 12, or another multiple of 6 REs.

Aspects of the disclosure are initially described in the context of wireless communications systems. Aspects of the disclosure are further illustrated by and described with reference to resource diagrams, apparatus diagrams, system diagrams, and flowcharts that relate to resource density for phase change estimation RSs.

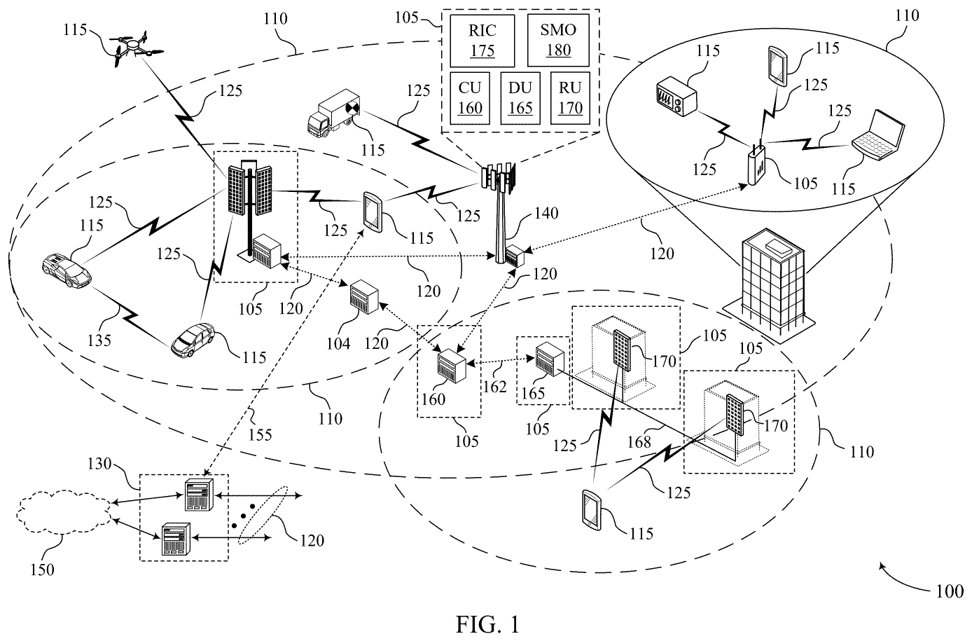

FIG. 1 shows an example of a wireless communications system 100 that supports resource density for phase change estimation RSs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support resource density for phase change estimation RSs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, RSs, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a RS (e.g., a cell-specific RS (CRS), a channel state information RS (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, RSs, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a UE 115 may be configured (e.g., by a network entity 105) with a density of phase change estimation RSs (which may be referred to as gRSs or some other terminology) for a MCS and RB allocation that may be based on a DMRS configuration and a quantity of antenna ports of the UE 115. For example, if the UE 115 has one antenna port for phase change estimation RSs and is configured with a Type-1 DMRS configuration, the UE 115 may be configured with one RE for phase change estimation RSs every 4, 8, or a multiple of 12 REs. Additionally, or alternatively, if the UE 115 has two antenna ports for phase change estimation RSs and is configured with a Type-1 DMRS configuration, the UE 115 may be configured with two REs for phase change estimation RSs every 4, 8, 12, or another multiple of 4 REs.

Additionally, or alternatively, if the UE 115 as one antenna port for phase change estimation RSs and is configured with a type 2 DMRS configuration, the UE 115 may be configured with one RE for phase change estimation RSs every 6, 12, or another multiple of 6 REs. Additionally, or alternatively, if the UE 115 has two antenna ports for phase change estimation RSs and is configured with a type 2 DMRS configuration, the UE 115 may be configured with two REs for phase change estimation RSs every 6, 12, or another multiple of 6 REs.

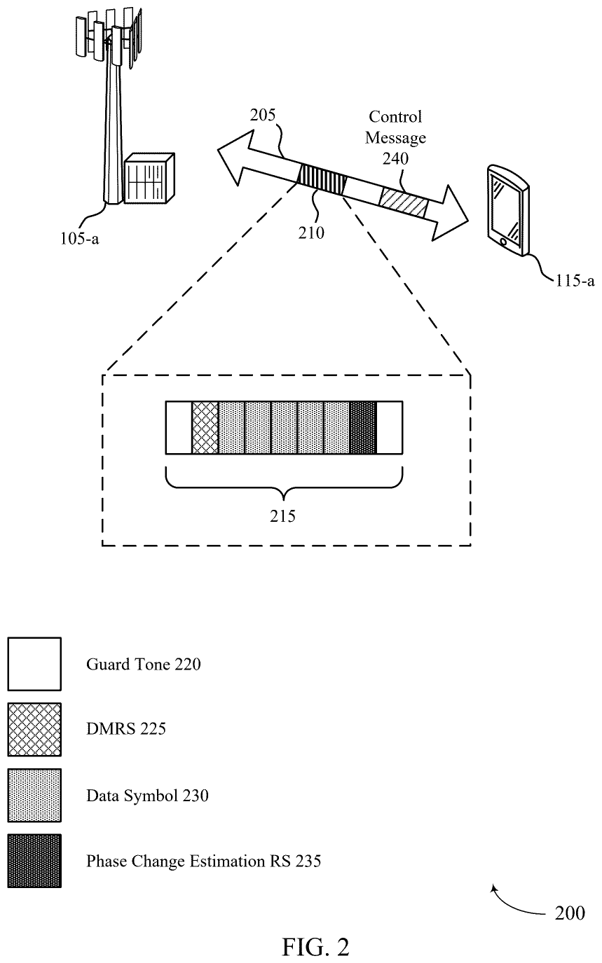

FIG. 2 shows an example of a wireless communications system 200 that supports resource density for phase change estimation RSs in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples, the wireless communications system 200 may be a SU-MIMO system or an MU-MIMO system. In a SU-MIMO system, the network entity 105-a may communicate with a UE 115, such as the UE 115-a. In a MU-MIMO system, the network entity 105-a may communicate with both the UE 115-a and another UE 115. In such cases, the UEs 115 may multiplex transmissions over a wireless channel. For example, the UEs 115 may implement TDM, FDM, code division multiplexing (CDM), or any combination thereof to communicate with the network entity 105-a.

In some examples, the network entity 105-a may communicate a message 210 with the UE 115-a (e.g., a PUSCH message or a PDSCH message communicated via a shared channel 205). The message 210 may be precoded before transmission (e.g., prior to transmission by the UE 115-a or prior to transmission by the network entity 105-a). The UE 115-a and the network entity 105-a may support transform precoding techniques to improve orthogonality of the message 210 and to reduce interference. The transform precoding may convert the message 210 from a frequency-domain signal to a time-domain signal. In some examples, the UE 115-a and the network entity 105-a may perform transform precoding using a discrete Fourier transform to convert the message 210 into a DFT-s-OFDM waveform.

Devices within the wireless communications system 200 may perform channel estimation procedures to establish communication and communicate signaling. In an example, the UE 115-a and the network entity 105-a may communicate one or more RSs for performing channel estimation. For example, the UE 115-a or the network entity 105-a may include the one or more RSs in the message 210. In some cases, the UE 115-a and the network entity 105-a may communicate the one or more RSs in bursts. For example, the UE 115-a may transmit the message 210 to the network entity 105-a via one or more slots 215. In the example of FIG. 2, the message 210 may include a guard tone 220 at a starting position of the slot 215, one or more DMRSs 225, one or more data symbols 230, and a guard tone 220 in a terminal position of the slot 215.

In some cases, there may be a phase jump boundary (e.g., a slot boundary, a PHY gap) between slots 215. In some examples, the UE 115-a may use the PHY gap to perform one or more tasks (e.g., RF reconfiguration). In some examples, however, a phase of a message 210 may change (e.g., jump) between a first slot 215 and a second slot 215. That is, a receiving device (e.g., the UE 115-a or the network entity 105-a) may not assume phase continuity across the phase jump boundary. Such a lack of phase continuity may result in a relatively reduced gain, increased overhead, and reduced performance (e.g., associated with intra-UE DMRS sharing in multiple start and length indicator values (SLIVs) or with joint DMSR processing in fluid SLIV). Additionally, the when DMRSs 225 are relatively further from the phase jump boundary (e.g., on one or both sides), the receiving device may not distinguish the phase change from a Doppler shift.

To estimate the phase change across the phase jump boundary for the message 210, a transmitting device (e.g., the UE 115-a or the network entity 105-a) may include one or more phase change estimation RSs 235 (e.g., a glue RS with a functionality similar to a phase tracking reference signal (PTRS)) in the message 210. That is, a phase change estimation RS 235 may be a reference signal used to provide additional information to a receiving device (e.g., the UE 115-a or the network entity 105-a) for determining a phase difference between slot boundaries, for example, when a message is transmitted across multiple slots. For example, the message 210 may include multiple phase change estimation RSs 235, including one phase change estimation RS 235 before the phase jump boundary and one phase change estimation RS 235 after the phase jump boundary. The UE 115-a or the network entity 105-a may multiplex the phase change estimation RSs 235 with one or more data symbols 230 of the message 210 to reduce signaling overhead for the phase change estimation RSs 235.

In some examples, a frequency domain density of the phase change estimation RSs 235 may be relatively similar to a frequency domain density of a PTRS. For example, the phase change estimation RSs 235 may occupy one RE in every X=2 or 4 RBs (e.g., and may puncture a message 210). The phase change estimation RSs 235 may be relatively close to the phase jump boundary (e.g., if a DMRS 225 is not present). In some examples, the phase change estimation RSs 235 may have a different waveform for downlink and for uplink.

The UE 115-a and the network entity 105-a may communicate the one or more reference signals (e.g., the DMRS 225, the phase change estimation RSs 235) via one or more respective antenna ports (e.g., DMRS ports, phase change estimation RS ports) of the UE 115-a. In some cases, the UE 115-a may include one or more coherent DMRS ports. Coherent DMRS ports may be driven by a same clock, and phase changes for each of the coherent DMRS ports may be the same. In some other cases, the UE 115 may be configured with multiple non-coherent DMRS ports. As an example, non-coherent DMRS ports may be driven by different clocks (e.g., associated with respective transmit chains or other components) and may drift apart in frequency over time. Accordingly, phase changes for each of the non-coherent DMRS ports may be different, and a receiving device (e.g., the network entity 105-a, the UE 115-a) may independently estimate the phase change for each DMRS port using a respective phase change estimation RS 235.

Each phase change estimation RS 235 may also be transmitted via one or more respective antenna ports (e.g., phase change estimation reference signal ports) of the UE 115-a or the network entity 105-a. In some cases, the phase change estimation RS 235 may be structured or configured such that a density of resource signaling included in the phase change estimation RS 235 is relatively less than the density of resource signaling associated with the DMRS 225. Because the network entity 105-a may use the phase change estimation RSs 235 for phase change estimation and/or channel estimation, the UEs 115 may limit the information included in the phase change estimation RSs 235 to reduce signaling overhead for the phase change estimation RSs 235.

In some examples, if FDM DMRS ports for transmitting the message 210 are non-coherent, the phase change estimation RSs 235 for each FDM DMRS port may be associated with an independent waveform. For example, a waveform for each FDM DMRS port may be based on a phase change estimation RS waveform of an associated CDM group. In a given CDM group, a phase change estimation RS 235 waveform may be a per-port phase change estimation RS 235 with resources corresponding to M REs per every X RBs (e.g., with full tome-domain (TD)/frequency domain (FD) orthogonal cover code (OCC) applied, which may enable the receiving device to estimate a per-port phase jump independently within the CDM group).

Additionally, or alternatively, for a CDM group of coherent DMRSs (e.g., for a CDM group in which there is not one or more non-coherent DMRS ports), the transmitting device may transmit a single-port phase change estimation RS 235 with M=1 RE per every X RBs (e.g., in a post-CDM fashion). For example, for every X RBs, the transmitting device may select one RE occupied by a CDM DMRS and may transmit the phase change estimation RS 235 via the selected RE. The transmitting device may repeat the transmission of the phase change estimation RS 235 in each active CDM DMRS ports with an additional scrambling (e.g., +1 or −1 scrambling).

Additionally, or alternatively, for a CDM group of coherent DMRSs, the transmitting device may transmit a single-port phase change estimation RS 235 with M=1 RE per every X RBs. For example, for every X RBs, the transmitting device may select one RE occupied by a CDM DMRS and may transmit the phase change estimation RS 235 via the selected RE. In such examples, the transmitting device may transmit the phase change estimation RS 235 in a single DMRS port of the CDM group. In such examples, for the receiving device to compare a phase jump across the phase jump boundary with another DMRS, the receiving device may use channel estimation associated with the DMRS to estimate a channel of the single DMRS port.

In some examples, the transmitting device may insert the phase change estimation RSs 235 at a relatively higher density to enable the receiving device to estimate a phase jump across the phase jump boundary (e.g., the slot boundary) or internal boundary of a fluid SLIV. For example, the transmitting device may transmit the phase change estimation RSs 235 at a density of 3 or more REs every 2 RBs (e.g., to enable joint channel estimation across the phase jump boundary to be relatively more accurate than an independent channel estimation before and after the phase jump boundary). However, inserting the phase change estimation RSs 235 may result in increased overhead in the wireless communications system 200. Accordingly, a relatively lower density of the phase change estimation RSs 235 may result in reduced processing and power consumption in the wireless communications system 200. The transmitting device may therefore use a density of the phase change estimation RSs 235 that is relatively low (e.g., for reduced overhead), but may still maintain a relatively higher quality of phase jump estimation for different MCS and RB allocations.

In some examples, to transmit PTRSs, the transmitting device may use a frequency density of PTRSs that is based on an allocated RBs and a time density that is based on a scheduled MCS. For example, if a quantity of allocated RBs is less than an RB threshold or if the MCS is less than an MCS threshold, the transmitting device may not transmit a PTRS. However, the phase change estimation RSs 235 may may be used to estimate the phase jump even for relatively lower quantities of allocated RBs (e.g., below the RB threshold). Additionally, as the receiving device may use the phase change estimation RSs 235 to estimate the phase jump across the phase jump boundaries, the symbols used for the phase change estimation RSs 235 may be relatively close to the phase jump boundaries (e.g., such that a Doppler shift may be negligible).

For example, the network entity 105-a may configure the UE 115-a to communicate the phase change estimation RSs 235 every M=1 or M=2 REs (e.g., if FD-OCC applies) in every X=2 or X=4 RBs. However, for a relatively smaller RB allocation (e.g., close to 2 or 4 RBs), such a density of the phase change estimation RSs 235 may not enable the receiving device to estimate the phase jump.

Accordingly, in some examples, the network entity 105-a may transmit a control message 240 including a resource configuration that configures the UE 115-a to receive or transmit the phase change estimation RSs 235 at a density that is based on a DMRS type, a quantity of the phase change estimation RS ports (e.g., a quantity of FDM ports configured for the phase change estimation RSs 235), an RB allocation, and a configured MCS. The UE 115-a and the network entity 105-a may accordingly communicate the phase change estimation RSs 235 via the shared channel 205 in accordance with the resource configuration. In some examples, the network entity 105-a may configure the UE 115-a to communicate the phase change estimation RSs 235 via REs (e.g., via a pattern of REs) that aligns with a configuration of DMRS REs. The transmitting device may accordingly reuse a DMRS symbol (e.g., in examples in which the DMRS symbol is present) across the phase jump boundary. For example, the network entity 105-a may configure the UE 115-a with a frequency density the phase change estimation RSs 235 of X/M.

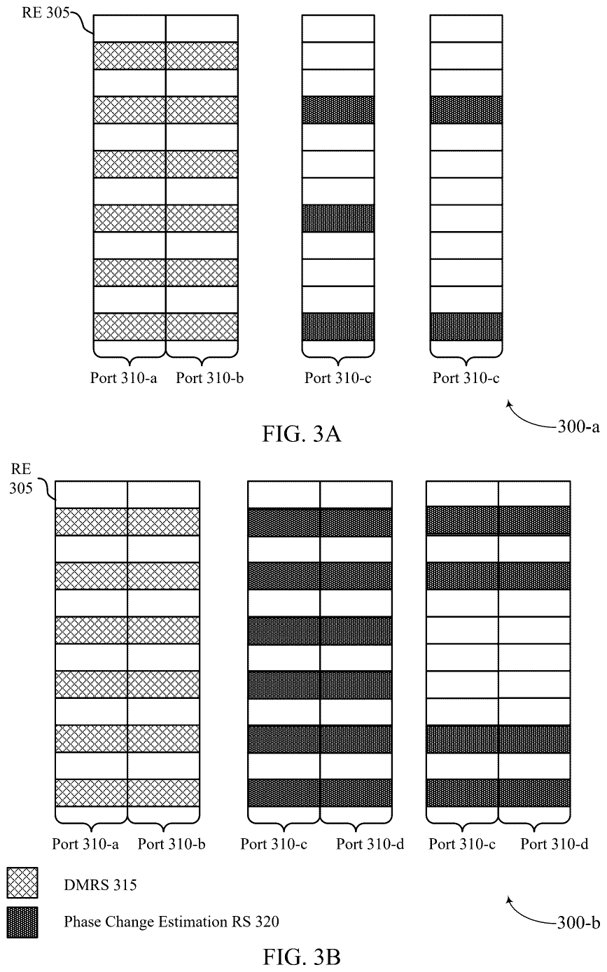

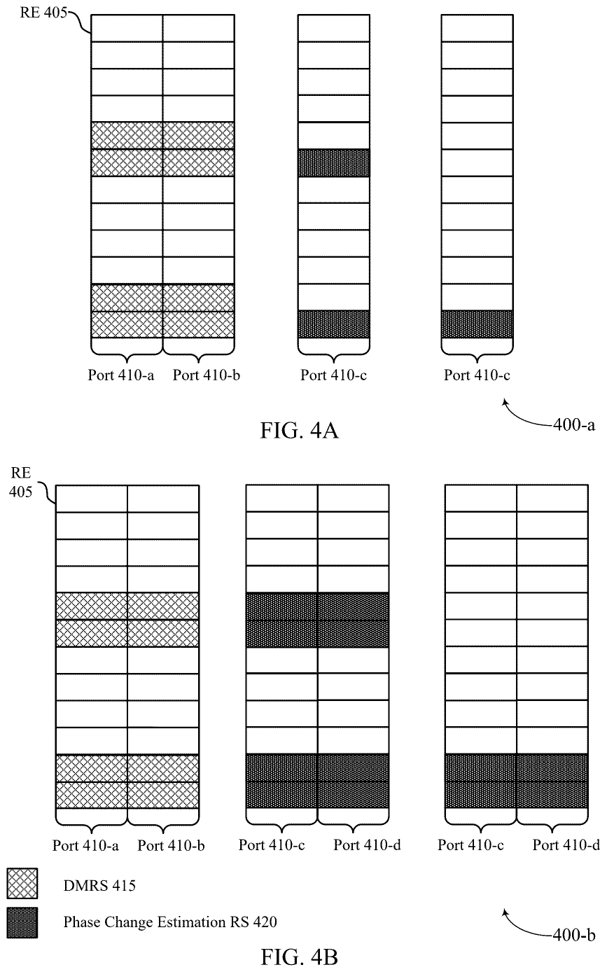

In some examples, as illustrated with reference to FIGS. 3A and 3B, the network entity 105-a may configure the UE 115-a to communicate a density of the phase change estimation RSs 235 (e.g., 1 or 2 REs every M REs in every X RBs) that is based on the UE 115-a being configured with a DMRS type 1 (e.g., with DMRSs 225 scheduled in every other RE). In some examples, as illustrated with reference to FIGS. 4A and 4B, the network entity 105-a may configure the UE 115-a to communicate a density of the phase change estimation RSs 235 (e.g., 1 or 2 REs every M REs in every X RBs) that is based on the UE 115-a being configured with a DMRS type 2 (e.g., with DMRSs 225 scheduled in two sets of two consecutive REs).

In some examples, M and X may be based on a frequency domain resource allocation (FDRA) (e.g., a configured RB allocation). For example, (e.g., if the phase jump is not frequency dependent), for large RB allocations, the network entity 105-a may configure the UE 115-a with a relatively lower value of X. In such examples, a quantity of REs allocated for the phase change estimation RSs 235 may be constant. Accordingly, the density may decrease (e.g., the value of X/M may increase) as a RB allocation increases. In some examples, a set of possible values of M may be increased for a larger RB allocation (e.g., from M=1/2/4 to M=1/2/4/8/16/32/64 and so on).

In some examples, M and X may be based on an MCS configured for communications. For example, for a given RB allocation, the network entity 105-a may configure the UE 115-a with a relatively more dense allocation of resources for the phase change estimation RSs 235 for a relatively higher MCS (e.g., a smaller value of X/M). For example, the network entity 105-a and the UE 115-a may identify one or more MCS thresholds for a given RB allocation (e.g., or an RB allocation range, such that similar RB allocations may share a same one or more MCS thresholds). In some examples, the network entity 105-a may configure the UE 115-a with the one or more MCS thresholds (e.g., via RRC configuration). As an illustrative example, Table 1 shows an example set of MCS thresholds (e.g., MCS₀, MCS₁) and corresponding values of X and M for a given RB allocation (e.g., or range of RB allocations, which may reduce an overall quantity of configured MCS thresholds).

TABLE 1

| MCS < MCS₀ | MCS_{0<} MCS < MCS₁ | MCS_{1<} MCS |
|---|---|---|
| X₀/M₀ | X₁/M₁ | X₂/M₂ |

FIGS. 3A and 3B show examples of a resource diagram 300-a and a resource diagram 300-b that support resource density for phase change estimation RSs in accordance with one or more aspects of the present disclosure. The resource diagram 300-a and the resource diagram 300-b may implement or may be implemented by aspects of the wireless communications system 100 or the wireless communications system 200. For example, resource diagram 300-a and the resource diagram 300-b may be implemented by a UE 115 or a network entity 105, which may be examples of the corresponding devices as described with reference to FIG. 1.

In some examples, as described with reference to FIG. 2, a UE 115 may be configured to communicate phase change estimation RSs 320 with a network entity 105. The network entity 105 may configure the UE 115 with a density of phase change estimation RSs 320 that is based on a DMRS type, a quantity of phase change estimation RS ports (e.g., FDM ports), an MCS, and an RB allocation configured at the UE 115.

For example, as illustrated with reference to FIG. 3A, for DMRS type 1, the UE 115 may be configured with two antenna ports 310 (e.g., an antenna port 310-a and an antenna port 310-b) for DMRSs 315. The UE 115 may be configured with one antenna port 310 (e.g., an antenna port 310-c) for phase change estimation RSs 320. In such examples (e.g., for small PUSCH or PDSCH messages), the network entity 105 may configure the UE 115 with resources for communicating a respective phase change estimation RS 320 in 1 RE 305 every set of M REs 305. As described herein, M may be equal to 4, 8, or a multiple of 12 REs 305. For example, for M=12, the UE 115 may be configured with one RE 305 per every X=1 RB.

As illustrated with reference to FIG. 3B, for DMRS type 1, the UE 115 may be configured with two antenna ports 310 (e.g., an antenna port 310-a and an antenna port 310-b) for DMRSs 315. The UE 115 may be configured with two antenna ports 310 (e.g., an antenna port 310-c and an antenna port 310-d) for phase change estimation RSs 320. In such examples (e.g., for small PUSCH or PDSCH messages), the network entity 105 may configure the UE 115 with resources for communicating a respective phase change estimation RS 320 in 2 REs 305 (e.g., REs that are one RE apart) every set of M REs 305. In some examples, the network entity 105 and the UE 115 may apply FD-OCC on the 2 REs 305 every M REs 305. As described herein, M may be equal to a multiple of 4 REs 305. In examples in which M=4 and the UE 115 has two antenna ports for communicating the phase change estimation RSs 320, the UE 115 may be configured with a density of phase change estimation RSs 320 that is the same as a density of DMRSs 315.

FIGS. 4A and 4B show examples of a resource diagram 400-a and a resource diagram 400-b that support resource density for phase change estimation RSs in accordance with one or more aspects of the present disclosure. The resource diagram 400-a and the resource diagram 400-b may implement or may be implemented by aspects of the wireless communications system 100, the wireless communications system 200, the resource diagram 300-a, or the resource diagram 300-b. For example, resource diagram 400-a and the resource diagram 400-b may be implemented by a UE 115 or a network entity 105, which may be examples of the corresponding devices as described with reference to FIG. 1.

In some examples, as described with reference to FIG. 2, a UE 115 may be configured to communicate phase change estimation RSs 420 with a network entity 105. The network entity 105 may configure the UE 115 with a density of phase change estimation RSs 420 that is based on a DMRS type, a quantity of phase change estimation RS ports (e.g., FDM ports), an MCS, an RB allocation configured at the UE 115, or a combination thereof.

For example, as illustrated with reference to FIG. 4A, for DMRS type 2, the UE 115 may be configured with two antenna ports 410 (e.g., an antenna port 410-a and an antenna port 410-b) for DMRSs 415. The UE 115 may be configured with one antenna port 410 (e.g., an antenna port 410-c) for phase change estimation RSs 420. In such examples (e.g., for small PUSCH or PDSCH messages), the network entity 105 may configure the UE 115 with resources for communicating a respective phase change estimation RS 420 in one RE 405 for each set of M REs 405. As described herein, M may be equal to a multiple of 6 REs 405. For example, for M=12, the UE 115 may be configured with one RE 405 per every X=1 RB.

As illustrated with reference to FIG. 4B, for DMRS type 2, the UE 115 may be configured with two antenna ports 410 (e.g., an antenna port 410-a and an antenna port 410-b) for DMRSs 415. The UE 115 may be configured with two antenna ports 410 (e.g., an antenna port 410-c and an antenna port 410-d) for phase change estimation RSs 420. In such examples (e.g., for small PUSCH or PDSCH messages), the network entity 105 may configure the UE 115 with resources for communicating a respective phase change estimation RS 420 in 2 REs 405 (e.g., REs that are one RE apart) for each set of M REs 405. In some examples, the network entity 105 and the UE 115 may apply FD-OCC on the 2 REs 305 every M REs 305. As described herein, M may be equal a multiple of 6 REs 305. In examples in which M=6 and the UE 115 has two antenna ports for communicating the phase change estimation RSs 420, the UE 115 may be configured with a density of phase change estimation RSs 420 that is the same as a density of DMRSs 415.

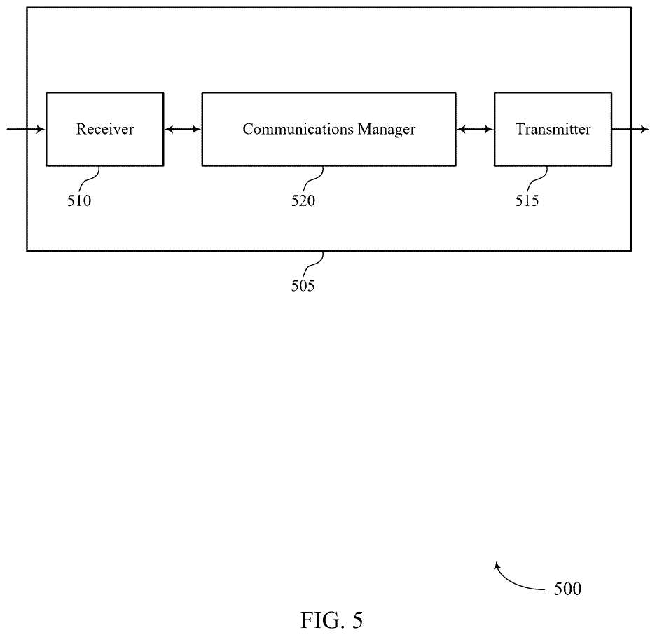

FIG. 5 shows a block diagram 500 of a device 505 that supports resource density for phase change estimation RSs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to resource density for phase change estimation RSs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to resource density for phase change estimation RSs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of resource density for phase change estimation RSs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof. The communications manager 520 is capable of, configured to, or operable to support a means for communicating, via the physical shared channel, the set of phase change estimation RSs in accordance with the resource configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for configuring a density of phase change estimation RSs, which may result in more efficient utilization of communication resources.

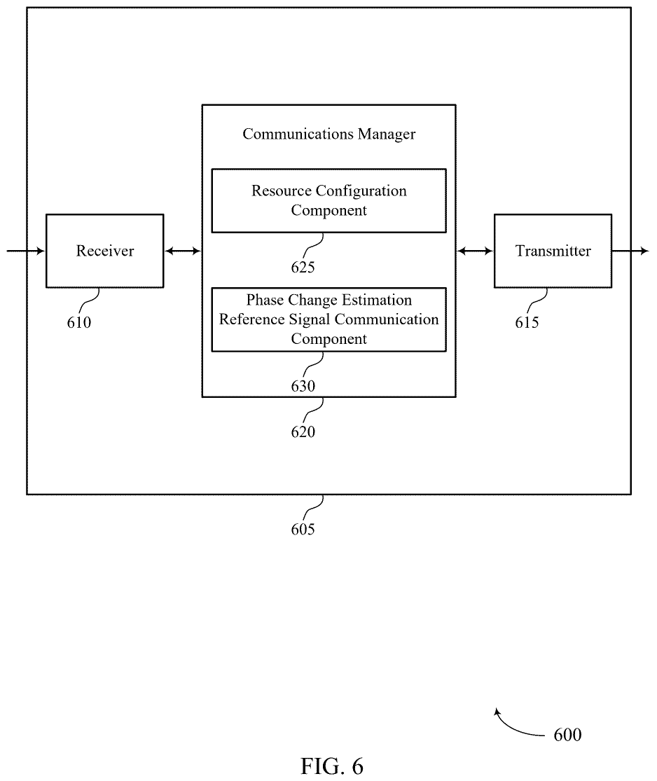

FIG. 6 shows a block diagram 600 of a device 605 that supports resource density for phase change estimation RSs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to resource density for phase change estimation RSs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource density for phase change estimation RSs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of resource density for phase change estimation RSs as described herein. For example, the communications manager 620 may include a resource configuration component 625 a phase change estimation RS communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The resource configuration component 625 is capable of, configured to, or operable to support a means for receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof. The phase change estimation RS communication component 630 is capable of, configured to, or operable to support a means for communicating, via the physical shared channel, the set of phase change estimation RSs in accordance with the resource configuration.

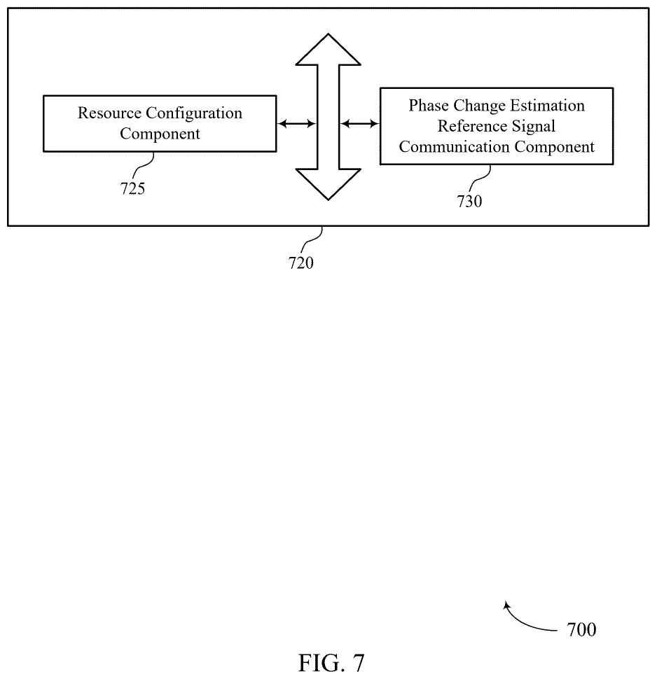

FIG. 7 shows a block diagram 700 of a communications manager 720 that supports resource density for phase change estimation RSs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of resource density for phase change estimation RSs as described herein. For example, the communications manager 720 may include a resource configuration component 725 a phase change estimation RS communication component 730, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The resource configuration component 725 is capable of, configured to, or operable to support a means for receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof. The phase change estimation RS communication component 730 is capable of, configured to, or operable to support a means for communicating, via the physical shared channel, the set of phase change estimation RSs in accordance with the resource configuration.

In some examples, the resource configuration includes a phase change estimation RS of the set of phase change estimation RSs allocated to one RE per set of REs based on the DMRS configuration including a type-one DMRS configuration, the quantity of antenna ports including one antenna port for the phase change estimation RS.

In some examples, the set of REs includes four REs, eight REs, or a multiple of twelve REs based on the type-one DMRS configuration.

In some examples, the resource configuration includes a respective phase change estimation RS of the set of phase change estimation RSs allocated to each of two REs per set of REs based on the DMRS configuration including a type-one DMRS configuration, the quantity of antenna ports including two antenna ports for the respective phase change estimation RSs.

In some examples, the set of REs includes a multiple of four REs based on the type-one DMRS configuration.

In some examples, an orthogonal cover code is applied to the respective phase change RSs. In some examples, each RE of the two REs are separated by one RE.

In some examples, the resource configuration includes a phase change estimation RS of the set of phase change estimation RSs allocated to one RE per set of REs based on the DMRS configuration including a type-two DMRS configuration, the quantity of antenna ports including one antenna port for the phase change estimation RS.

In some examples, the set of REs includes a multiple of six REs based on the type-two DMRS configuration.

In some examples, the resource configuration includes a respective phase change estimation RS of the set of phase change estimation RSs allocated to each of two REs per set of REs based on the DMRS configuration including a type-two DMRS configuration, the quantity of antenna ports including two antenna ports for the respective phase change estimation RSs.

In some examples, the set of REs includes six REs or twelve REs based on the type-two DMRS configuration.

In some examples, an orthogonal cover code is applied to the respective phase change RSs.

In some examples, a density of the set of phase change estimation RSs is based on a frequency domain resource allocation for the physical shared channel.

In some examples, a density of the set of phase change estimation RSs is based on the MCS. In some examples, the density is from a set of densities that includes respective densities for different MCS thresholds.

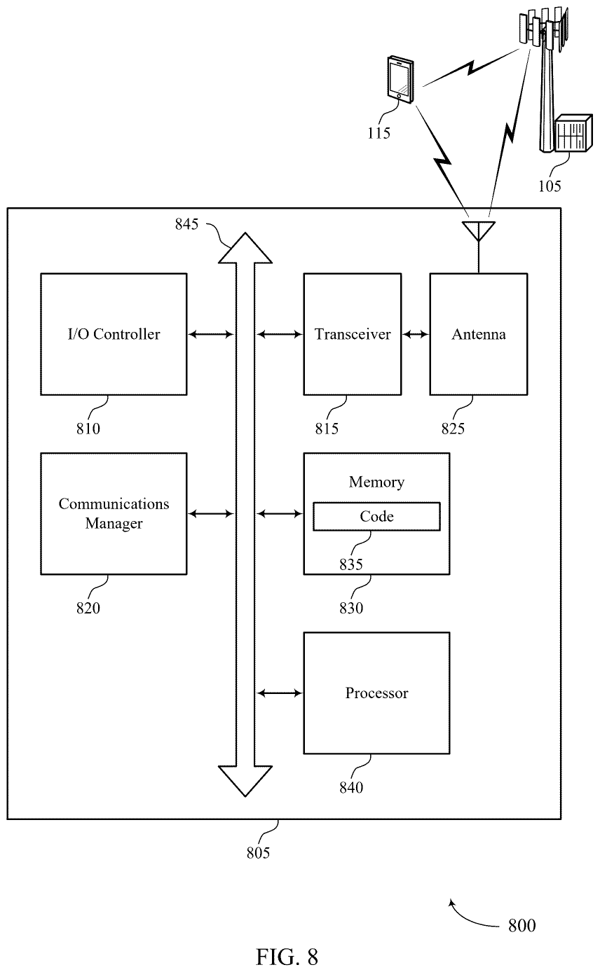

FIG. 8 shows a diagram of a system 800 including a device 805 that supports resource density for phase change estimation RSs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting resource density for phase change estimation RSs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof. The communications manager 820 is capable of, configured to, or operable to support a means for communicating, via the physical shared channel, the set of phase change estimation RSs in accordance with the resource configuration.

By including or configuring the communications manager 820 in accordance with examples as described herein, the device 805 may support techniques for configuring a density of phase change estimation RSs, which may result in improved communication reliability, more efficient utilization of communication resources, and improved coordination between devices. For example, the density of phase change estimation RSs may be associated with relatively more accurate channel estimation or relatively reduced overhead as compared to some other densities of phase change estimation RSs.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of resource density for phase change estimation RSs as described herein, or the at least one processor 840 and the at least one memory 830 may be otherwise configured to, individually or collectively, perform or support such operations.

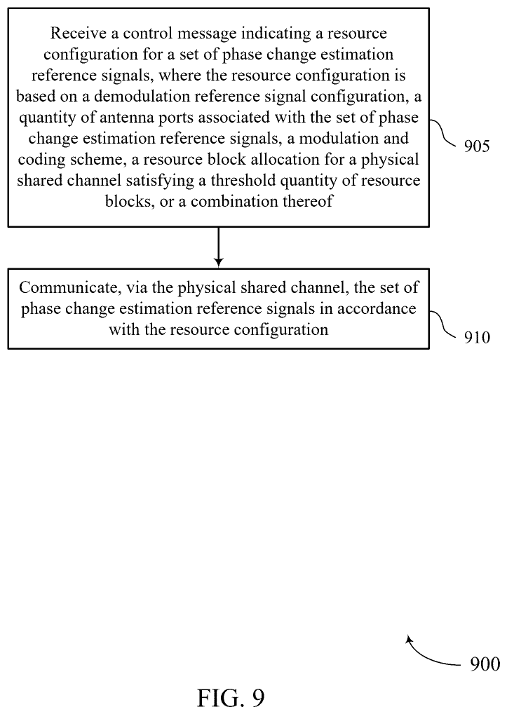

FIG. 9 shows a flowchart illustrating a method 900 that supports resource density for phase change estimation RSs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a control message indicating a resource configuration for a set of phase change estimation RSs, where the resource configuration is based on a DMRS configuration, a quantity of antenna ports associated with the set of phase change estimation RSs, a MCS, a RB allocation for a physical shared channel satisfying a threshold quantity of RBs, or a combination thereof. The operations of 905 may be performed in accordance with examples as disclosed herein. In some examples, aspects of the operations of 905 may be performed by a resource configuration component 725 as described with reference to FIG. 7.

At 910, the method may include communicating, via the physical shared channel, the set of phase change estimation RSs in accordance with the resource configuration. The operations of 910 may be performed in accordance with examples as disclosed herein. In some examples, aspects of the operations of 910 may be performed by a phase change estimation RS communication component 730 as described with reference to FIG. 7.

The following provides an overview of aspects of the present disclosure:

Aspect 1: A method for wireless communications by a UE, comprising: receiving a control message indicating a resource configuration for a set of phase change estimation RSs, wherein the resource configuration is based at least in part on a DMRS configuration, a quantity of antenna ports associated with the set of phase change estimation RSs, a MCS, a RB allocation for a physical shared channel satisfying a threshold quantity of RBs, or a combination thereof; and communicating, via the physical shared channel, the set of phase change estimation RSs in accordance with the resource configuration.

Aspect 2: The method of aspect 1, wherein the resource configuration comprises a phase change estimation RS of the set of phase change estimation RSs allocated to one resource element per set of resource elements based at least in part on the DMRS configuration comprising a type-one DMRS configuration, the quantity of antenna ports comprising one antenna port for the phase change estimation RS.

Aspect 3: The method of aspect 2, wherein the set of resource elements comprises four resource elements, eight resource elements, or a multiple of twelve resource elements based at least in part on the type-one DMRS configuration.

Aspect 4: The method of aspect 1, wherein the resource configuration comprises a respective phase change estimation RS of the set of phase change estimation RSs allocated to each of two resource elements per set of resource elements based at least in part on the DMRS configuration comprising a type-one DMRS configuration, the quantity of antenna ports comprising two antenna port for the respective phase change estimation RSs.

Aspect 5: The method of aspect 4, wherein the set of resource elements comprises a multiple of four resource elements based at least in part on the type-one DMRS configuration.

Aspect 6: The method of any of aspects 4 through 5, wherein an OCC is applied to the respective phase change reference signals, and each resource element of the two resource elements are separated by one resource element.

Aspect 7: The method of aspect 1, wherein the resource configuration comprises a phase change estimation RS of the set of phase change estimation RSs allocated to one resource element per set of resource elements based at least in part on the DMRS configuration comprising a type-two DMRS configuration, the quantity of antenna ports comprising one antenna port for the phase change estimation RS.

Aspect 8: The method of aspect 7, wherein the set of resource elements comprises a multiple of six resource elements based at least in part on the type-two DMRS configuration.

Aspect 9: The method of aspect 1, wherein the resource configuration comprises a respective phase change estimation RS of the set of phase change estimation RSs allocated to each of two resource elements per set of resource elements based at least in part on the DMRS configuration comprising a type-two DMRS configuration, the quantity of antenna ports comprising two antenna port for the respective phase change estimation RSs.

Aspect 10: The method of aspect 9, wherein the set of resource elements comprises six resource elements or twelve resource elements based at least in part on the type-two DMRS configuration.

Aspect 11: The method of any of aspects 9 through 10, wherein an OCC is applied to the respective phase change reference signals.

Aspect 12: The method of any of aspects 1 through 11, wherein a density of the set of phase change estimation RSs is based at least in part on a frequency domain resource allocation for the physical shared channel.

Aspect 13: The method of any of aspects 1 through 12, wherein a density of the set of phase change estimation RSs is based at least in part on the MCS, the density is from a set of densities that comprises respective densities for different MCS thresholds.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating a resource configuration for a set of phase change estimation reference signals, wherein the resource configuration is based at least in part on a demodulation reference signal configuration, a quantity of antenna ports associated with the set of phase change estimation reference signals, a modulation and coding scheme, a resource block allocation for a physical shared channel satisfying a threshold quantity of resource blocks, or a combination thereof; and
communicate, via the physical shared channel, the set of phase change estimation reference signals in accordance with the resource configuration.

2. The UE of claim 1, wherein the resource configuration comprises a phase change estimation reference signal of the set of phase change estimation reference signals allocated to one resource element per set of resource elements based at least in part on the demodulation reference signal configuration comprising a type-one demodulation reference signal configuration, the quantity of antenna ports comprising one antenna port for the phase change estimation reference signal.

3. The UE of claim 2, wherein the set of resource elements comprises four resource elements, eight resource elements, or a multiple of twelve resource elements based at least in part on the type-one demodulation reference signal configuration.

4. The UE of claim 1, wherein the resource configuration comprises a respective phase change estimation reference signal of the set of phase change estimation reference signals allocated to each of two resource elements per set of resource elements based at least in part on the demodulation reference signal configuration comprising a type-one demodulation reference signal configuration, the quantity of antenna ports comprising two antenna ports for the respective phase change estimation reference signals.

5. The UE of claim 4, wherein the set of resource elements comprises a multiple of four resource elements based at least in part on the type-one demodulation reference signal configuration.

6. The UE of claim 4, wherein an orthogonal cover code is applied to the respective phase change estimation reference signals, and wherein each resource element of the two resource elements are separated by one resource element.

7. The UE of claim 1, wherein the resource configuration comprises a phase change estimation reference signal of the set of phase change estimation reference signals allocated to one resource element per set of resource elements based at least in part on the demodulation reference signal configuration comprising a type-two demodulation reference signal configuration, the quantity of antenna ports comprising one antenna port for the phase change estimation reference signal.

8. The UE of claim 7, wherein the set of resource elements comprises a multiple of six resource elements based at least in part on the type-two demodulation reference signal configuration.

9. The UE of claim 1, wherein the resource configuration comprises a respective phase change estimation reference signal of the set of phase change estimation reference signals allocated to each of two resource elements per set of resource elements based at least in part on the demodulation reference signal configuration comprising a type-two demodulation reference signal configuration, the quantity of antenna ports comprising two antenna port for the respective phase change estimation reference signals.

10. The UE of claim 9, wherein the set of resource elements comprises six resource elements or twelve resource elements based at least in part on the type-two demodulation reference signal configuration.

11. The UE of claim 9, wherein an orthogonal cover code is applied to the respective phase change estimation reference signals.

12. The UE of claim 1, wherein a density of the set of phase change estimation reference signals is based at least in part on a frequency domain resource allocation for the physical shared channel.

13. The UE of claim 1, wherein a density of the set of phase change estimation reference signals is based at least in part on the modulation and coding scheme, and wherein the density is from a set of densities that comprises respective densities for different modulation and coding scheme thresholds.

14. A method for wireless communications by a user equipment (UE), comprising:
receiving a control message indicating a resource configuration for a set of phase change estimation reference signals, wherein the resource configuration is based at least in part on a demodulation reference signal configuration, a quantity of antenna ports associated with the set of phase change estimation reference signals, a modulation and coding scheme, a resource block allocation for a physical shared channel satisfying a threshold quantity of resource blocks, or a combination thereof; and
communicating, via the physical shared channel, the set of phase change estimation reference signals in accordance with the resource configuration.

15. The method of claim 14, wherein the resource configuration comprises a phase change estimation reference signal of the set of phase change estimation reference signals allocated to one resource element per set of resource elements based at least in part on the demodulation reference signal configuration comprising a type-one demodulation reference signal configuration, the quantity of antenna ports comprising one antenna port for the phase change estimation reference signal.

16. The method of claim 15, wherein the set of resource elements comprises four resource elements, eight resource elements, or a multiple of twelve resource elements based at least in part on the type-one demodulation reference signal configuration.

17. The method of claim 14, wherein the resource configuration comprises a respective phase change estimation reference signal of the set of phase change estimation reference signals allocated to each of two resource elements per set of resource elements based at least in part on the demodulation reference signal configuration comprising a type-one demodulation reference signal configuration, the quantity of antenna ports comprising two antenna port for the respective phase change estimation reference signals.

18. The method of claim 17, wherein the set of resource elements comprises a multiple of four resource elements based at least in part on the type-one demodulation reference signal configuration.

19. The method of claim 14, wherein the resource configuration comprises a phase change estimation reference signal of the set of phase change estimation reference signals allocated to one resource element per set of resource elements based at least in part on the demodulation reference signal configuration comprising a type-two demodulation reference signal configuration, the quantity of antenna ports comprising one antenna port for the phase change estimation reference signal.

20. A non-transitory computer-readable medium storing code for wireless communications, the code comprising instructions executable by one or more processors to:
receive a control message indicating a resource configuration for a set of phase change estimation reference signals, wherein the resource configuration is based at least in part on a demodulation reference signal configuration, a quantity of antenna ports associated with the set of phase change estimation reference signals, a modulation and coding scheme, a resource block allocation for a physical shared channel satisfying a threshold quantity of resource blocks, or a combination thereof; and
communicate, via the physical shared channel, the set of phase change estimation reference signals in accordance with the resource configuration.
